(19) United States
(12) Patent Application Publication
(10) Pub. No.: US 2021/0200246 A1
(43) Pub. Date: Jul. 1, 2021

(54) METHOD AND SYSTEM FOR DETERMINING THE POSITION OF A MOVING OBJECT

(71) Applicant: DONECLE, LABEGE (FR)

(72) Inventor: Alban DERUAZ-PEPIN, Toulouse (FR)

(21) Appl. No.: 16/070,502

(22) PCT Filed: Dec. 19, 2016
(86) PCT No.: PCT/FR2016/053546

§ 371 Date: Jul. 16, 2018

(30) Foreign Application Priority Data
Jan. 14, 2016 (FR) 1650303

(51) Int. Cl. G05D 1/10; G01S 17/89; G01S 7/481; G06K 9/00

(52) U.S. Cl. CPC G05D 1/1064; G06K 9/0063; G01S 7/4815; G01S 17/89

(57) ABSTRACT

The invention relates to a method for determining the relative position of a moving object in relation to an environment modelled by a set of geometric surfaces that form a 3D model in accordance with a frame of reference in the environment, comprising a step (10) of measuring a plurality of distances from the object to the environment in at least one direction, so as to obtain a set of defined points in a frame of reference of the moving object, a step of evaluating a difference between said set of points and the 3D mesh of the environment, and a step (20) of determining the relative position of the moving object in the frame of reference of the environment from said difference.

### 1. TECHNICAL FIELD OF THE INVENTION

The invention relates to a method and to a system for determining the relative position of a moving object in relation to an environment. In particular, the invention relates to a method and to a system for determining the position of an airborne drone (a flying robot, also known as unmanned aerial vehicle, for example of the multi-rotor or helicopter type) or a surface inspection robot in a known environment such as a hangar containing the object of which the surface is to be inspected.

### 2. TECHNICAL BACKGROUND

Moving objects, such as drones or robots that move autonomously in space, need to constantly know their position in the environment in which they are moving around.

If they are moving around in an open environment (outdoors), the moving objects are usually positioned using geolocation, for example by global positioning systems (GPS), which make it possible achieve a high level of precision.

However, the main drawback of global positioning systems is that they do not work indoors. Solutions have therefore been sought to allow the positioning of moving objects indoors.

For example, one solution proposed was to start from a known position of the moving object and to determine the position of the object by measuring the movements made by the object from this known position. This solution does not make it possible to detect errors or any lack of precision in the movement over time, however, and these accumulate over time and therefore result in an incorrect position that cannot be corrected. Furthermore, the solution uses inertial reference systems which, despite having a good level of precision which makes it possible to minimise these errors, are expensive and heavy (often over 1 kg), which is incompatible with use in an airborne drone.

Alternatively, it has been proposed to use a system of beacons which are placed in the environment in advance, such as radio transceivers. By equipping the moving object with a transceiver, it is thus possible to estimate its position by techniques involving triangulation relative to the other beacons. However, this solution is expensive and takes a long time to implement since the beacons need to be arranged and their precise positions need to be determined (by calibration).

A solution has been sought to allow positioning indoors that overcomes at least some of these drawbacks.

### 3. OBJECTS OF THE INVENTION

The object of the invention is to overcome at least some of the drawbacks of the known positioning methods and systems.

In particular, the object of the invention is to provide, in at least one embodiment of the invention, a positioning method that makes it possible to position a moving object in an indoor environment.

The object of the invention is also to provide, in at least one embodiment, a rapid positioning method that can be executed on low-power processors.

The object of the invention is also to provide, in at least one embodiment, a precise positioning method.

The object of the invention is also to provide, in at least one embodiment, a positioning method that does not require any modifications to the environment in which the object is moving.

The object of the invention is also to provide, in at least one embodiment, a positioning system that can be on board the moving object.

### 4. DESCRIPTION OF THE INVENTION

To do this, the invention relates to a method for determining the relative position of a moving object in relation to an environment modelled by a set of geometric surfaces that form a 3D model in accordance with a frame of reference in the environment, comprising:
a step of measuring a plurality of distances from the object to the environment in at least one direction, so as to obtain a set of defined points in a frame of reference of the moving object,
a step of evaluating a difference between said set of points and the 3D model of the environment,
a step of determining the relative position of the moving object in the frame of reference of the environment from said difference.

A method according to the invention therefore allows a moving object to be positioned in a wholly or partly known environment without requiring beacons to be positioned. The “environment” is understood to mean the volume within which the moving object moves, together with the elements that make up said volume, for example a hangar containing an aircraft of which the surfaces need to be inspected. When carrying out surface inspection on elements having large dimensions, the inspected elements are known and can be 3D modelled, or have been modelled for other applications, by computer-aided design (CAD) software.

The method uses the measurements of distances of the object from the environment at all times, and makes it possible to determine its relative position in relation to the environment. For example, a drone flying around an aircraft for inspection purposes would know its position at all times and, if there were a defect on the surface of the aircraft, would be able to determine the position of this defect relative to its own position and therefore locate it on the aircraft.

The method implemented is therefore rapid and cost-effective in terms of resources for execution; it can be easily integrated on board the moving object, and uses an on-board processor that consumes little energy and allows for real-time processing. Part of the method, in particular steps that only need to be executed once and are irrespective of the position of the moving object or of the measured distances (for example pre-processing steps linked to the 3D modelling) can be executed outside the moving object, the results of these steps being provided to the on-board processor in order to improve the execution speed of the steps processed thereby.

The speed of execution of the method also allows it to be executed more frequently, and thus ensures that the position of the moving object is rapidly tracked, and therefore said object can move faster.

Even though the method is particularly advantageous indoors due to the lack of geolocation, it can also be used outdoors for applications requiring improved accuracy in a known environment, for example the inspection of an aircraft outdoors, the surface of a wind turbine or a vessel in a dry dock.

Advantageously and according to the invention, the 3D model is a 3D polygon mesh, and the geometric surfaces are polygons.

Modelling the 3D environment using a 3D polygon mesh allows simple modelling and more rapid processing of the different steps of the method. In addition, any 3D model involving more complex geometric surfaces can be approximated by a 3D polygon mesh in accordance with techniques that are well known to a person skilled in the art.

Advantageously and according to the invention, the step of measuring a plurality of distances is carried out by at least one laser scanner (also known as laser rangefinder).

Advantageously and according to this previous aspect of the invention, the step of measuring a plurality of distances is carried out by at least two laser scanners configured to scan in secant planes.

Preferably, each additional laser scanner is configured to carry out scanning in planes secant to the scanning planes of the other laser scanners.

Advantageously and according to the invention, the step of evaluating a difference between the set of points and the 3D model of the environment comprises:
a step of converting the set of points in the frame of reference of the moving object into a point cloud in the frame of reference of the environment from an estimation of the position and from an attitude of the moving object,
a step of calculating, for each point in said point cloud, a norm between said point and a surface of the 3D model of the environment.

The attitude of the moving object corresponds to the orientation of the object in space, expressed by Euler angles θ, φ and ψ, which are known to a person skilled in the art.

Advantageously, a method according to the invention comprises, prior to the step of calculating, for each point in said point cloud, a norm between said point and a surface of the 3D model of the environment:
a step of breaking down the environment into superimposed cubes, such that each point in the environment is contained within a plurality of cubes,
a step of determining, for each cube, surfaces of the 3D model of the environment having a non-zero intersection with the cube,

and the step of calculating, for each point in said point cloud, a norm between said point and a surface of the 3D model of the environment comprises:
a step of selecting one of the cubes, referred to as the centred cube, in which the point in the point cloud is located and in which the point in the point cloud is furthest from each of its faces,
a step of retrieving the list of the surfaces having an intersection with the centred cube, referred to as close surfaces,
a step of calculating a norm between the point and each close surface,
a step of determining the surface closest to the point from the close surfaces, said closest surface being the surface of which the norm between said surface and the point is the lowest, said norm being considered to be the norm between the point and the 3D model of the environment.

Advantageously, the step of breaking down the environment into superimposed cubes and the step of determining, for each cube, surfaces of the 3D model of the environment having a non-zero intersection with the cube can be executed in advance, and the result of these steps can be saved in the memory of the moving object to allow more rapid processing. Indeed, these steps are not linked to the position of the object or to the distance measurements that are taken.

According to this aspect of the invention, breaking down the environment into cubes and calculating the norm between each point and the close surfaces allows the norm between each point and the 3D model of the environment to be calculated rapidly and cost-effectively in terms of resources, since only a calculation of the norms with the close surfaces is carried out, rather than with all the surfaces.

The distance of the point cloud from the 3D model is all the norms from each point in the point cloud to the 3D model, in particular to the surface of the 3D model closest to this point.

Advantageously and according to the invention, the points for which the norm of the point is greater than a predetermined threshold, referred to as isolated points, are extracted from the point cloud, and the method comprises a step of detecting an obstacle in which the close isolated points are grouped together to form volumes representing obstacles, and said volumes are recorded.

According to this aspect of the invention, the method makes it possible to isolate the points corresponding to obstacles that are not included in the 3D model of the environment, to process said points and to take them into account when positioning the moving object, in order to prevent the moving object from coming into contact with said obstacles. The volumes representing the obstacles are recorded, and can be taken into account in the navigation and can be tracked as the moving object moves around.

Advantageously, the method according to the invention comprises a step of removing points corresponding to the ground or the ceiling of the environment from the point cloud.

According to this aspect of the invention, the method makes it possible to limit the number of points to be processed by removing from the point cloud the points corresponding to the ground or the ceiling of the environment that are of little use when the altitude of the moving object or an estimate of this altitude is available; the moving object knows that the ground and the ceiling correspond to particular constant altitudes, and does not need to be aware of the points forming the ground or the ceiling. The altitude is known either by direct measurement or by estimation.

The method is therefore more rapid because the number of points to be processed has been reduced.

Advantageously, a method according to the invention comprises a step of removing ambiguous or redundant points from the point cloud.

According to this aspect of the invention, the method makes it possible to limit the number of points to be processed by removing the points corresponding to the ambiguous or redundant distance measurements from the point cloud. The ambiguous points are the points corresponding to a point measurement on the edges of a surface or a measurement on a surface having a low angle of incidence, which may be incorrect. The redundant points are the points located on a surface of which the point cloud already comprises enough points to define said surface.

The method is therefore more rapid because the number of points to be processed has been reduced.

The invention also relates to a method for navigating a moving object in an environment, comprising at least one step of moving the moving object, characterised in that a position of the moving object is determined, during the movement step, by a determining method according to the invention.

The invention also relates to a method for navigating a moving object in an environment, comprising at least one step of moving the moving object, characterised in that a position of the moving object and positions of volumes corresponding to obstacles are determined by a determining method according to the invention, and in that it comprises at least one step of avoiding said volumes corresponding to obstacles.

The invention also relates to a system for determining the relative position of a moving object in relation to an environment modelled by a 3D model in accordance with a frame of reference in the environment, which system is on board said moving object and characterised in that it comprises:
means for measuring a plurality of distances from the object to the environment in at least one direction, so as to obtain a set of defined points in a frame of reference of the moving object,
modules for evaluating a difference between said set of points and the 3D model of the environment,
modules for determining the relative position of the moving object in the frame of reference of the environment from said difference.

The measuring means are for example sensors on board the module, such as at least one laser scanner, preferably two laser scanners, configured to scan in secant planes, a depth measurement camera (of the red green blue depth (RGBD) type), a stereo vision device, a millimetre-wave radar, etc., or a combination of said sensors.

The module for evaluating the distance and the module for determining the relative position of the moving object are on board the moving object. However, some calculations that are not linked to the measured distances or to the position of the moving object can be carried out on a separate computer, and can be provided to the determining system in advance in order to improve the processing speed of the different means that it comprises.

The invention also relates to a computer program product that can be downloaded from a communication network and/or stored on a computer-readable and/or processor-executable medium, characterised in that it comprises program code instructions for implementing the determining method according to the invention.

A computer program product of this type makes it possible to determine the position of a moving object in which it is executed rapidly, requiring few processing resources and thus having low energy consumption.

The invention also relates to a computer-readable storage means which is wholly or partly removable and stores a computer program comprising a set of computer-executable instructions for implementing the determining method according to the invention.

Advantageously, a determining system according to the invention implements a determining method according to the invention.

Advantageously, a determining method according to the invention is implemented by a system according to the invention.

The invention also relates to a computer program product that can be downloaded from a communication network and/or stored on a computer-readable and/or processor-executable medium, characterised in that it comprises program code instructions for implementing the determining method according to the invention.

The invention also relates to a computer-readable storage means which is wholly or partly removable and stores a computer program comprising a set of computer-executable instructions for implementing the determining method according to the invention.

The invention also relates to a determining method, to a navigation method, to a system, to a computer program product and to a storage means characterised in combination by some or all of the features described previously or hereinafter.

### 5. LIST OF THE FIGURES

Other aims, features and advantages of the invention will become apparent from reading the following description, which is given by way of non-limiting example with reference to the accompanying drawings, in which:

FIG. 1 is a schematic diagram of a method according to an embodiment of the invention;

FIG. 2 is a diagram of a polygon of a 3D mesh of the environment.

### 6. DETAILED DESCRIPTION OF AN EMBODIMENT OF THE INVENTION

The following embodiments are examples. Although the description refers to one or more embodiments, this does not necessarily mean that each reference relates to the same embodiment, or that the features apply only to a single embodiment. Single features of different embodiments can also be combined in order to provide other embodiments. In the drawings, the scales and proportions are not strictly respected for the sake of illustration and clarity.

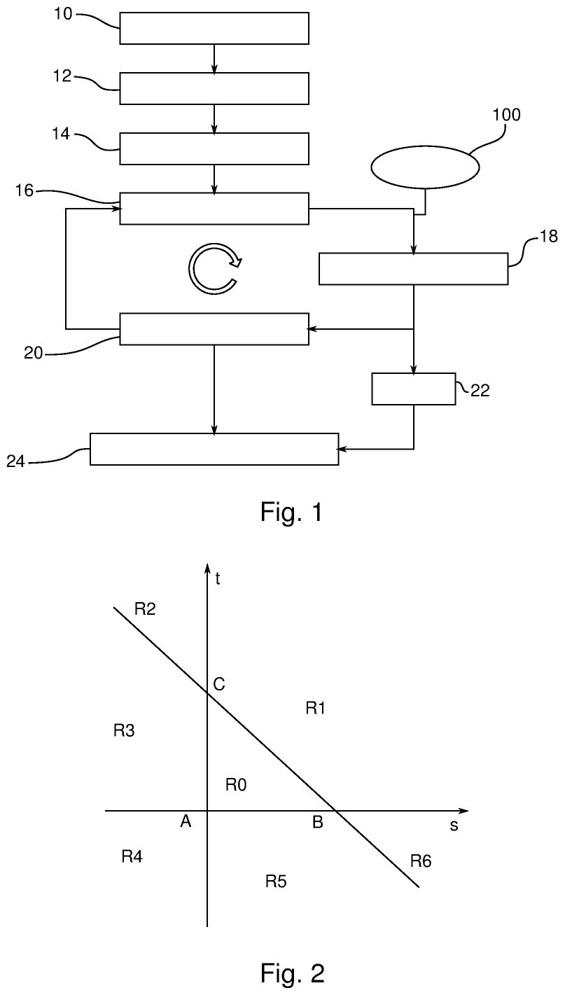

FIG. 1 schematically shows a method for determining the position of a moving object in relation to an environment modelled by a set of geometric surfaces that form a 3D model in accordance with a frame of reference in the environment, according to an embodiment of the invention. All or part of this determining method is implemented by a determining system on board a moving object, according to an embodiment of the invention. The method is advantageously described for a moving object that moves in three dimensions and is a flying object such as a drone, for example of the helicopter or multi-rotor type.

In this embodiment, the 3D model is a 3D polygon mesh, i.e. the geometric surfaces forming the 3D model are polygons. However, the invention also applies to any type of 3D model, in particular 3D models that use more complex geometric surfaces (spheres, cylinders, ellipses and cones in particular).

The determining method comprises a first step 10 of measuring a plurality of distances from the moving object to the environment in at least one direction, so as to obtain a set of defined points in a frame of reference of the moving object, using means for measuring a plurality of distances from the object to the environment in at least one direction.

Said measuring means are for example sensors, such as at least one laser scanner, preferably two laser scanners, which scan in secant planes, a depth measurement camera (of the red green blue depth (RGBD) type), a stereo vision device, a millimetre-wave radar, etc., or a combination of said sensors.

The distance measurements are in the form of pairs (solid angle; measured distance in this solid angle) in accordance with a frame of reference of the moving object and in relation to a known point on the moving object, typically the position of the measuring means, which is known relative to the centre of gravity of the moving object.

A laser scanner may for example carry out distance measurements at a low angular pitch (for example 0.25°) and over a wide angular range (270° or more), which makes it possible to obtain a large number of pairs (solid angle; distance). The use of a plurality of laser scanners having different orientations and/or mirrors makes it possible to obtain measurements in different planes.

According to other embodiments, acquisition means such as RGBD cameras or stereo vision cameras, or of the radar or sonar type, make it possible to obtain the distance measurements over several dimensions without the need for scanning.

The pairs (solid angle; distance) form a set of points in a frame of reference of the moving object; the pair corresponds to the spherical coordinates of the points in the set of points in a frame of reference of the moving object.

The method then comprises an optional step 12 of removing points corresponding to the ground or the ceiling of the environment from the point cloud by means of a module for removing points corresponding to the ground or the ceiling of the environment from the point cloud.

Extracting the measured distances that correspond to the ground or the ceiling from all the measured distances makes it possible to reduce the number of distances taken into account in the rest of the determining method.

This extraction requires the attitude of the object to be known, and in one embodiment, requires the altitude thereof to be known, which is measured by a specific sensor, or requires the altitude of the moving object to be estimated, which is derived from the previous position of the moving object, taking into account the approximate movement from this last position.

From the attitude, in the first instance it is possible to determine the height of each point associated with the pair (solid angle; distance) in the frame of reference of the moving object, i.e. to obtain a coordinate along a vertical Oz axis pointing upwards and originating from the moving object. Therefore, the points at positive Z coordinates are above the object, and the points at negative Z coordinates are below the object.

An interval [ZC−DZ, ZC+DZ] is then constructed, having a centre ZC and amplitude 2DZ, for each surface to be removed (typically the ground and the ceiling). The value DZ may be constant, for example 10 cm, or may be a function of the vertical speed VZ, for example DZ=DZmin+K*|VZ|, where |VZ| indicates the absolute value of VZ, and DZmin and K are coefficients.

According to a first embodiment, ZC is calculated using the altitude of the object:
For the ground: ZC=−ZE, where ZE is the altitude of the object relative to the ground
For the ceiling: ZC=H−ZE, where H is the height of the ceiling

According to a second embodiment, ZC is calculated directly from the coordinates Z of the points:
For the ground: ZC=(minimum of all the Z coordinates)+DZ
For the ceiling: ZC=(maximum of all the Z coordinates)−DZ

The first embodiment has the advantage of being more rapid since the interval is known immediately without the need to calculate the minimum or maximum at all the points, and has the advantage of working even when there are “holes” in the ground or ceiling.

The second embodiment has the advantage of not using the altitude of the object, and can in particular work even if the estimation of the altitude is no longer working.

A third, preferred, embodiment is to use the first embodiment when a good estimation of the altitude is available, and to use the second embodiment when it is not.

Finally, all the points for which the vertical coordinate is included in this interval are then extracted.

Said extracted points can also be used to carry out a new estimation of the altitude by applying a RANSAC-type algorithm to the vertical coordinates of said points, in which algorithm the average of all the vertical coordinates is calculated, a predetermined percentage (for example 10%) of the points for which the vertical coordinates are furthest from the average is removed, and the average is recalculated from the remaining points; said average is the estimation of the height of the ground for the points corresponding to the ground and the estimation of the height of the ceiling for the points corresponding to the ceiling.

The method then comprises an optional step 14 of removing ambiguous or redundant points from the point cloud, using means for removing ambiguous or redundant points from the point cloud.

This step has several aims; a first aim is to prevent measured distances that are too similar from being duplicated, for example a set of measured distances representing the same plane. It is not necessary to keep several hundreds of points in order to define a planar surface.

A second aim is to reduce the number of unreliable measured distances, in particular when the distance-measuring means are laser scanners which take measurements by scanning. For example, for close solid angles, the measured distance may vary significantly when the environment comprises surfaces that are far away; the intermediate points between said long distances may be incorrect. Furthermore, the measurements on a surface with which the laser of the scanner has a low angle of incidence (close to 0°) may be incorrect.

A third aim is to ensure that there is a minimum number of points in all directions, in order to obtain a consistent result.

In order to fulfil these aims, the step of removing the distances comprises:
a step of attributing a non-ambiguity score S1=f1 (distance to the closest edge/measured distance), f1 being for example a Gaussian function returning a number between 0 (very close to the edge) and 1 (far from any edge),
a step of attributing a non-ambiguity score S2=f2 (angle of incidence), f2 being for example a Gaussian function returning a number between 0 (grazing angle of 0°) and 1 (orthogonal angle of 90°),
a step of combining the scores to form a global score S=S1×S2, between 0 and 1,
a step of breaking down the measurements by angular sectors of a sphere, for example (360/30)²=144 angular sectors of 30° by 30°,
for each angular sector, and while the global score of a measurement of the sector is above a predetermined threshold (for example 0.5), a step of selecting the measurement having the best global score and of removing the close P points that are the closest to this point (for example P=20). Preferably, the points that are very close to a selected measurement may be used to consolidate said selected measurement before being removed. The consolidation is for example an average or a median over 3 points.

A reduced list of distance measurements is thus obtained, which makes it possible to accelerate the processing of the following steps while removing data which may be incorrect and keeping a sufficient number of points in each angular sector.

The method then comprises a step of evaluating a difference between said set of points and the 3D mesh of the environment, and a step 20 of determining the relative position of the moving object in the frame of reference of the environment from said difference. These steps may be carried out several times in a loop in order to allow the position of the moving object to be refined.

The step of evaluating a difference between said set of points and the 3D mesh of the environment comprises a step 16 of converting the set of points in the frame of reference of the moving object into a point cloud in the frame of reference of the environment from an estimation of the position of the moving object, and a step 18 of calculating, for each point in said point cloud, a norm between said point and a polygon of the 3D mesh of the environment.

The conversion is carried out by determining the change of basis matrix of the frame of reference of the moving object relative to the frame of reference of the environment, based on an estimation of the position and the attitude of the object. The frame of reference of the environment is preferably an Oxyz-type orthonormal frame of reference.

The position of the object may be estimated in several different ways according to the embodiment.

The attitude of the object is generally known using an inertial system, such as a low-cost inertial measurement system.

If the method has already been implemented, the last position provided by the method can be used as a position estimation. This last position may possibly be refined if the moving object approximately knows the speed and the direction of movement of the object, for example by means of an accelerometer.

If the method has not already been implemented (typically when the moving object has been started up and when the method is first initiated), the following method will be used to determine the initial position (x, y, z, psi):

Where the initial position and orientation of the moving object are established (the moving object is arranged in a precise, known position and orientation), this position and orientation are provided as an estimation of the position of the object and the following steps of the determining method are executed a fixed number of times (for example 5 times), and then the consistency of this position is verified; a position is deemed consistent if a precision indicator, representing the average of the norms of each point with a surface of the environment (described below), is below a threshold (for example the average distance is less than 20 cm) and the percentage of points of which the norm between said point and the environment is less than a maximum distance is above a threshold (for example over 75%). If the position is consistent, the position is used as an estimation of the position; otherwise, the method below, referred to as the mesh method, is used.

If the initial position and orientation are not specified, the only information known is the height of the moving object relative to the ground and therefore its altitude, which is denoted h. It is therefore known that the drone is in the equation plane z=h. This plane (which, in reality, is a rectangle since the environment is of a finite size) is meshed with a certain interval (for example 1 m), of which each point constitutes an estimation of the position to be used in the following steps of the method. If an estimation of the orientation is available, for example outdoors with the magnetic field, said estimation is used. Otherwise, for each position, the orientation psi of the moving object is also discretised using an interval, for example 20°. Each pair (position, orientation) is provided to initiate the following steps of the method, and these steps are executed a fixed number of times (for example 5 times). As soon as a pair satisfies the above-defined consistency criterion, it is used as an estimation of the initial position.

Some environments allow the initial position of the moving object to be approximately determined. For example, where the environment contains an aeroplane, the distance between the moving object and a fuselage of the aeroplane and/or the distance between the moving object and a wing of the aeroplane can be extracted, which makes it possible to considerably limit the number of positions to be tested.

If a previous position estimation is available, the close positions will be tested in priority.

In addition, the meshing method allows a valid position to be found when the position of the moving object would have been lost as it moved. To do this, the search mesh is made up of points on a sphere around the last known position (said sphere having, for example, a radius of 1 m). Likewise, the points closest to the last known position will be tested in priority. The algorithm continues until a position confirming the consistency criterion is found. If no position is found on the sphere, the radius thereof is increased (for example, by an interval of 1 m) and the algorithm starts again.

Furthermore, the estimation of the altitude may arise from the results of the optional step of extracting the measured distances corresponding to the ground of the environment, if it was executed.

The 3D mesh of the environment is for example a representation of the environment in the form of a set of polygons combined to form an approximation of the surfaces of the environment. These polygons are triangles or quadrangles, for example.

The aim of the step 18 of calculating, for each point in said point cloud, a norm between said point and a polygon of the 3D mesh of the environment is to determine, for each point in the point cloud, the norm of this point with the closest polygon, and to deduce therefrom a norm of the point cloud with the 3D mesh that represents the error of the position used in the step of converting the distances measured into a point cloud in the frame of reference of the environment.

To do this, the 3D mesh of the environment (represented by the reference sign 100) is divided up in advance by a cube pattern comprising superimposed cubes covering the entirety of the environment. Said step of breaking down the environment into superimposed cubes, such that each point in the environment is contained within a plurality of cubes, comes after the following steps:
Dividing the environment into a pattern of adjacent cubes that are of equal size and are not superimposed, covering the entirety of the environment. For example, the length of the sides of a cube is 1 m.
Duplicating the cube pattern and translating the duplication of a cube half-length along the Ox axis of the frame of reference of the environment. Twice as many cubes are therefore obtained as in the initial pattern.
Duplicating the new cube pattern and translating the duplication of a cube half-length along the Oy axis of the frame of reference of the environment. Twice as many cubes are therefore obtained as in the preceding step, and four times as many as in the initial pattern.
Duplicating the new cube pattern and translating the duplication of a cube half-length along the Oz axis of the frame of reference of the environment. Twice as many cubes are therefore obtained as in the preceding step, and eight times as many as in the initial pattern.

Owing to this cube pattern, any point in the environment that is not included in a face of a cube and is not at the edge of the environment is found in exactly eight cubes, and of these eight cubes there is always one cube, referred to as the centred cube, at which the point is furthest away from each of the faces of said cube, i.e. it is at more than a quarter of the edge length of each face of the cube (being 25 cm for a cube having 1 m edges).

A list of the cubes in the cube pattern is advantageously organised such that, from a point for which the coordinates are expressed in the frame of reference of the environment, a simple mathematical formula makes it possible to easily find the centred cube corresponding to this point: the cubes have an index linked to their position in the environment.

The method then comprises a step of determining, for each cube, polygons of the 3D mesh of the environment having a non-zero intersection with the cube. In this step, for each cube, the list of the polygons is scanned to retrieve those for which the intersection with the volume of the cube is non-zero, i.e. the polygons which are contained in the cube or which intersect with at least one face of the cube. The results of this step are stored so as to be rapidly accessible to an on-board system. This method would apply similarly to the list of the surfaces for defining which surfaces have a non-zero intersection with the cubes.

These steps of breaking down the environment into superimposed cubes and determining, for each cube, polygons of the 3D mesh of the environment having a non-zero intersection with the cube are steps which are not linked to the distance measurements or to the position of the moving object, and which can be executed once for the environment. They can therefore be executed by an external computer, and only the results including the list of the indexed cubes and the triangles associated with each indexed cube having an intersection with this cube are stored by the on-board system.

The method comprises, in the step 18 of calculating, for each point in said point cloud, a norm between said point and a polygon of the 3D mesh of the environment, a step of selecting one of the cubes, referred to as the centred cube, in which the point in the point cloud is furthest from each of its faces. Owing the above-described preferential indexing of the cubes, the centred cube is determined rapidly due to the coordinates of the point. For example, the calculation for determining the index of the cube for a point P having coordinates (xₚ, yₚ, zₚ) is:

Index=K₁+K₂*Floor(xₚ/L)+K₃*Floor(yₚ/L)+K₄*Floor(zₚ/L)

where K₁, K₂, K₃, K₄ are integers as a function of the position of the mesh and its size, L is the half-length of an edge of a cube and Floor( ) is the integer part mathematical function.

The method then comprises a step of retrieving the list of the polygons having an intersection with the centred cube, referred to as close polygons. These polygons are retrieved rapidly from the centred cube due to the above-described storage that links, to each cube, the polygons with which it has a non-zero intersection.

If the list does not contain any polygons, the point is referred to as an isolated point and is removed from the list of points for the remainder of the step of evaluating a distance between the set of points and the 3D mesh of the environment. The isolated points are grouped together in a list of isolated points, which allows obstacles to be detected.

The method then comprises a step of calculating a norm between the point and each close polygon.

For example, if the polygons are triangles, each norm is calculated in the following manner: Namely:
P is the point for which the norm between itself and the triangle is to be calculated,
A triangle T having apexes A, B and C configured by the equation

T(s,t)=A+sB+tC where (s,t)∈D={(s,t), t∈[0.1],s+t≤1}
The distance to the square of P at a point T(s,t) of the triangle is

Q(s,t)=|T(s,t)−P|²

The aim of the algorithm is to find the pair (s,t) corresponding to the point minimising Q. The algorithm for rapidly calculating the norm of a point at a triangle is defined as follows:
1. Calculating the pair (s,t) minimising the gradient of Q, the pair (s, t) defining a point referred to as the candidate point.
2. If the candidate point belongs to the triangle (therefore s and t belong to D), the minimising pair (s,t) is found, and the algorithm is terminated.
3. If the candidate point is not in the triangle, the minimum of Q is realised at the edges of the triangle.

In this case, the candidate point is the orthogonal projection of P onto the plane defined by the triangle, but this point does not belong to the surface enclosed by the triangle.

The space within the plane defined by the triangle is thus partitioned into a plurality of regions as shown with reference to FIG. 2, which shows the triangle ABC and is on a 2D frame of reference (A, s, t). Therefore, the candidate point is in one of the regions 1 to 6, respectively numbered R1, R2, R3, R4, R5, R6, the region 0 (numbered R0) corresponding to point 2 described above.
4. Determining the corresponding region according to the values of s and t of the candidate point:

Simple geometric considerations directly give the region corresponding to the candidate point. Example: if s<=0 and t<=0, the candidate point is therefore in region 4.

5. Determining the point, referred to as the minimising point, on the contours of the triangle minimising the distance to the candidate point:
Region 1: the curves at the level of Q are ellipses centred on the candidate point. The minimising point is therefore situated either on]CB [ if the gradient cancels itself out in this area, in which case the minimising pair (s,t) is obtained, or at C or B. The algorithm is terminated.
Region 2: the curves at the level of Q are also ellipses, and therefore the minimising point is located on [CA] or on [CB]. Geometric considerations on the gradient of Q at C make it possible to determine if the minimising point is on [CA] or [CB]. According to the same principle as region 1, the nullity or non-nullity of the gradient in the segment makes it possible to obtain the minimising pair (s,t). The algorithm is terminated.
Regions 3 and 5: the reasoning is similar to that for region 1.
Regions 4 and 6: the reasoning is similar to that for region 2.

The norm between the point P and the minimising pair (s,t) characterising the minimising point located in the area D of the triangle, which norm corresponds to the norm between the point P and the triangle, is lastly returned.

The calculations can be accelerated further by a certain number of parameters on the triangles being pre-calculated, and can be stored in the memory with the information on said triangles.

For other polygonal shapes, the calculations can be made in a similar way, by adaptation to the specific geometry of the polygons. Alternatively, each polygon can be replaced by a set of triangles.

The calculation step 18 then comprises a step of determining the polygon closest to the point from the close polygons, said closest polygon being the polygon of which the norm between said polygon and the point is the lowest, said norm being considered to be the norm between the point and the 3D mesh of the environment.

The sum of the norms of all the points divided by the number of points (except for isolated points), referred to as a precision indicator, makes it possible to estimate the precision of the position estimation.

The method also calculates the vector error, in the form of three-dimensional vectors, between each point and the closest polygon.

The vector error comprises three components along the three axes x, y, z of the frame of reference of the environment.

In the step 20 of determining the relative position of the moving object in the frame of reference of the environment, all these norms between each point, which represent the distance between the set of points and the 3D mesh of the environment, are processed so as to minimise this distance. To do this, the Gauss-Newton gradient descent algorithm can be used. Each iteration of the algorithm uses a POS_init estimation of the position (along x, y and z) to calculate a POS_calc estimation of the position (along x, y and z), and comprises the following steps:
creating a vector r of a size N comprising, at each coordinate, the norm between each point and the 3D mesh,
creating a matrix J of a size M×N, Jacobian matrix corresponding to the gradient of r relative to the POS_init vector,
selecting a value of a real β between 0 and 1 (generally 1 or reduced if the moving object is not moving, or is only moving a little),
applying the Gauss-Newton descent (if J^{T}*J is invertible):

POS_calc=POS_init−*β*(J^{T}*J)⁻¹**J*r

If the altitude of the moving object is known, the calculation can be made by fixing the position along the axis z to the known altitude value, thus improving the speed of the calculation.

When the variation between POS_init and POS_calc is considered to be low enough, the algorithm is terminated and the POS_calc value is considered to be the relative position of the moving object in the frame of reference of the environment. Otherwise, the algorithm starts again and the POS_calc value is used as the POS_init value for the next iteration.

In order to allow the method to be accelerated, it is possible to take into account the vector errors in order to estimate, for each x, y and z component, the correction direction between the estimated position and a corrected position.

To do this, the minimum value and the maximum value of each component is determined from all the vector errors, for example xₘᵢₙ and xₘₐₓ for the x component:
If these minimum and maximum values have different signs, a direction cannot be deduced.
If these two values are positive, the correction to be made is in the positive direction, and the correction is at least equal to xₘₘ. This correction of xₘᵢₙ can therefore be made directly in order to arrive at the corrected position more rapidly.
If these two values are negative, the correction to be made is in the negative direction, and the correction is at least equal to xₘₐₓ. This correction of xₘₐₓ can therefore be made directly in order to arrive at the corrected position more rapidly.

The same process is carried out for the y and z components.

The method also comprises a step 22 of processing the isolated points, referred to as a step of detecting an obstacle in which the isolated points are grouped together to form volumes representing the obstacles.

For example, the environment is broken down into adjacent, boxel-type cubes, and the method scans the set of boxels to determine if it comprises at least one isolated point; if this is the case, the boxel is considered to be an obstacle boxel. The close obstacle boxels are grouped together to form volumes, for example by means of mathematical morphology operations such as two dilation steps followed by an erosion step. The boxels contained in these volumes are indexed and recorded as being obstacles, thus defining a position of the detected obstacles. This information on the position of recorded obstacles can aid in navigation (avoiding obstacles) and makes it possible to track obstacles over time.

The method is implemented at a predetermined frequency so as to track the change in the position of the moving object in accordance with the desired constraints (for example 50 Hz).

Once the position is determined and the potential obstacles are determined, the moving object can use this information to implement a method 24 for the navigation and guidance necessary for said object to move. The navigation method 24 comprises at least one movement step, during which the position of the moving object and any potential obstacles is determined, in particular in a regular manner over the course of the movement.

The different steps of the method are implemented by different modules, such as processors, microcontrollers, calculators, etc. A step may be implemented by a single dedicated module, or a plurality of steps may be implemented by the same module.

The invention is not restricted to the described embodiment. In particular, the invention may be applicable to moving objects on wheels, in which case the calculations can be simplified by limiting the calculations to the x and y coordinates corresponding to a 2D movement on the ground.

1. A method for determining the relative position of a moving object in relation to an environment modelled by a set of geometric surfaces that form a three-dimensional (3D) model in accordance with a frame of reference in the environment, comprising:
measuring a plurality of distances from the object to the environment in at least one direction, so as to obtain a set of defined points in a frame of reference of the moving object,
evaluating a difference between said set of points and the 3D model of the environment, and
determining the relative position of the moving object in the frame of reference of the environment from said difference.

2. The method according to claim 1, wherein the 3D model is a 3D polygon mesh, and the geometric surfaces are polygons.

3. The method according to either claim 1 wherein the measuring of a plurality of distances is carried out by at least one laser scanner.

4. The method according to claim 3, wherein the measuring of a plurality of distances is carried out by at least two laser scanners configured to scan in secant planes.

5. The method according to claim 1 wherein the evaluating of a difference between the set of points and the 3D model of the environment comprises:
converting the set of points in the frame of reference of the moving object into a point cloud in the frame of reference of the environment from an estimation of the position and from an attitude of the moving object, and
calculating, for each point in said point cloud, a norm between said point and a surface of the 3D model of the environment.

6. The method according to claim 5, wherein prior to the calculating, for each point in said point cloud, norm between said point and surface of the 3D model of the environment:
breaking down the environment into superimposed cubes, such that each point in the environment is contained within a plurality of cubes, and
determining, for each cube, surfaces of the 3D model of the environment having a non-zero intersection with the cube,
the calculating, comprising:
selecting one of the cubes, referred to as the centred cube, in which the point in the point cloud is located and in which the point in the point cloud is furthest from each of its faces,
retrieving the list of the surfaces having an intersection with the centred cube, referred to as close surfaces,
calculating a norm between the point and each close surface, and
determining the surface closest to the point from the close surfaces, said closest surface being the surface of which the norm between said surface and the point is the lowest, said norm being considered to be the norm between the point and the 3D model of the environment.

7. The method according to claim 6, wherein the points for which the norm of the point is greater than a predetermined threshold comprise isolated points, and are extracted from the point cloud, and method additionally comprising detecting an obstacle in which the close isolated points are grouped together to form volumes representing obstacles, and said volumes are recorded.

8. The method according to claim 5, further comprising removing points corresponding to the ground or the ceiling of the environment from the point cloud.

9. The method according to claim 5, further comprising removing ambiguous or redundant points from the point cloud.

10. A method for navigating a moving object in an environment, comprising moving the moving object, and determining a position of the moving object in relation to an environment modelled by a set of geometric surfaces that form a three-dimensional (3D) model in accordance with a frame of reference in the environment, by:
measuring a plurality of distances from the object to the environment in at least one direction, so as to obtain a set of defined points in a frame of reference of the moving object,
evaluating a difference between said set of points and the 3D model of the environment, and
determining the relative position of the moving object in the frame of reference of the environment from said difference.

11. A method for navigating a moving object in an environment, comprising moving the moving object, wherein a position of the moving object and positions of volumes corresponding to obstacles are determined in relation to an environment modelled by a set of geometric surfaces that form a three-dimensional (3D) model in accordance with a frame of reference in the environment by
measuring a plurality of distances from the object to the environment in at least one direction, so as to obtain a set of defined points in a frame of reference of the moving object,
evaluating a difference between said set of points and the 3D model of the environment, and,
determining the relative position of the moving object in the frame of reference of the environment from said difference,
wherein the points for which the norm of the point is greater than a predetermined threshold comprise isolated points, and are extracted from the point cloud, the method additionally comprising detecting an obstacle in which the close isolated points are grouped together to form volumes representing obstacles, and said volumes are recorded, and
avoiding said volumes corresponding to obstacles.

12. A system for determining the relative position of a moving object in relation to an environment modelled by a 3D model in accordance with a frame of reference in the environment, which system is on board said moving object, the system comprising:
a host computer with memory and at least one processor, and
computer program instructions executing in the memory and enabled to perform:
measuring a plurality of distances from the object to the environment in at least one direction, so as to obtain a set of defined points in a frame of reference of the moving object,
for evaluating a difference between said set of points and the 3D model of the environment,
determining the relative position of the moving object in the frame of reference of the environment from said difference.

13. (canceled)

14. A non-transitory computer-readable storage medium storing therein a computer program comprising a set of computer-executable instructions for implementing a method for navigating a moving object in an environment, comprising moving the moving object, and determining a position of the moving object in relation to an environment modelled by a set of geometric surfaces that form a three-dimensional (3D) model in accordance with a frame of reference in the environment comprising:
measuring a plurality of distances from the object to the environment in at least one direction, so as to obtain a set of defined points in a frame of reference of the moving object,
evaluating a difference between said set of points and the 3D model of the environment, and
determining the relative position of the moving object in the frame of reference of the environment from said difference.
